(19) United States
(12) Patent Application Publication
(10) Pub. No.: US 2015/0364918 A1
(43) Pub. Date: Dec. 17, 2015

(54) SYSTEM AND METHOD OF OPTIMIZING LOAD CURRENT IN A STRING OF SOLAR PANELS

(71) Applicant: Innorel System Private Limited, Bangalore (IN)

(72) Inventors: Saumitra Singh, Bangalore (IN); Ibinu Alaudeen Nadeera, Bangalore (IN)

(21) Appl. No.: 14/734,971

(22) Filed: Jun. 9, 2015

(30) Foreign Application Priority Data
Jun. 11, 2014 (IN) 2844/CHE/2014
Jun. 11, 2014 (IN) 2845/CHE/2014

(51) Int. Cl. H02J 1/14; H02J 7/35

(52) U.S. Cl. CPC H02J 1/14; H02J 7/35

(57) ABSTRACT

A system and method for optimizing load current in a string of solar panels. A string of solar panels includes a microprocessor coupled to the string of solar panels. The system includes a first DC-to-DC converter comprising input terminals coupled to a load and output terminals coupled to each solar panel in the string of solar panels. The first DC-to-DC converter is operable to supply a compensatory power for compensating a drop in the peak current arising due to shading of one or more solar panels. Moreover, the system includes a second DC-to-DC converter coupled to the first DC-to-DC converter. The second DC-to-DC converter is operable as one of a voltage adder and a voltage subtractor to generate a compensatory voltage for compensating a drop in the load current arising due to panel mismatch among the string of solar panels.

### PRIORITY APPLICATION

This application claims priority of Indian Provisional Patent Application No. 2844/CHE/2014 filed on 11 Jun. 2014, and Indian Provisional Patent Application No. 2845/CHE/2014 filed on 11 Jun. 2014, which is incorporated in its entirety herewith.

### CROSS REFERENCE TO RELATED APPLICATION

The present application is related to co-pending US Patent Application entitled, “MAXIMIZING POWER OUTPUT OF SOLAR PANEL ARRAYS”, Publication Number: US20140239725, application Ser. No. 13/773,667, Filed: 22 Feb. 2013.

### TECHNICAL FIELD

The present invention generally relates to a distributed Maximum Power Point Tracking (MPPT) system for solar panels and more specifically to optimizing a load current to achieve Maximum Power Point in a string of solar panels.

### BACKGROUND

Recent decades have witnessed the advent of several devices to harness solar energy. Photovoltaic cells have the ability to convert solar energy into electrical energy. Electrical power generated in a photovoltaic cell is proportional to voltage across the photovoltaic cell and current associated with the photovoltaic cell. The photovoltaic cell functions at maximum efficiency when voltage and current values associated with the photovoltaic cell are equal to voltage and current values corresponding to maximum power point of the photovoltaic cell. The maximum power point varies with variation in temperature, incident radiation on the photovoltaic cell and current flowing through the photovoltaic cell. Existing systems track the maximum power point of the photovoltaic cell continuously. The process of tracking the maximum power point of the photovoltaic cell continuously is referred to as Maximum Power point Tracking (MPPT).

In one existing system, a photovoltaic cell is connected to an input terminal of a DC/DC convertor. The output terminals of the DC/DC convertor are connected to a load. The DC/DC convertor maintains voltage across the photovoltaic cell at maximum power point of the photovoltaic cell. Further, the DC/DC convertor converts the voltage across the photovoltaic cell to a voltage required by the load. As a result, the DC/DC convertor transfers the power generated in the photovoltaic cell to the load. However, a single photovoltaic cell has a limited power generating capability. In order to increase the power generating capability, a plurality of photovoltaic cells has to be interconnected to form a photovoltaic module. This requires a plurality of DC-to-DC converters, which is not cost-efficient.

In another existing system, a solar panel is connected to an input terminal of a DC/DC convertor in parallel. The output terminals of the DC/DC convertor are connected to a load in parallel. The DC/DC convertor converts voltage across the solar panel to a voltage required by the load. Further, the DC/DC convertor maintains the voltage across the solar panel at a voltage required to maintain maximum power point across individual photovoltaic cells in the solar panel. However, the DC/DC convertor consumes a fraction of power supplied from the solar panel, thereby reducing the power delivered to the load.

In one exemplary illustration of the system, a DC/DC convertor consumes 10 percent (%) of power supplied from the solar panel. If the solar panel generates 10 Watts, the DC/DC converter consumes 1 Watt. The power delivered to the load is 9 Watts. As a result, efficiency of the solar panel is improved by reducing the power supplied to the DC/DC convertor for conversion. Thus, there is a necessity for a system which minimizes power supplied to the DC/DC convertor while maintaining voltage across photovoltaic cells at a maximum power point.

Another problem arises when individual photovoltaic cells are connected in series in a photovoltaic module. Series connected photovoltaic cells carry the same current. However, output current of individual photovoltaic cells depends on the amount of incident light on respective photovoltaic cell. Amount of incident light varies because of factors such as shading, accumulation of bird droppings, leaves and dust on the photovoltaic module, and angle of the sun. Different photovoltaic cells carry different values of current. Difference in current output causes mismatches among the photovoltaic cells in the photovoltaic module. As a result, current flowing through the photovoltaic module becomes equal to the lowest value of current generated by an individual photovoltaic cell in the photovoltaic module. Power generated by the photovoltaic module is proportional to the net voltage of photovoltaic cells in the photovoltaic module and the current flowing through the photovoltaic module. As a result, power generated by the photovoltaic module is proportional to lowest value of current generated by individual photovoltaic cells in the photovoltaic module. Further, mismatches in current generation from photovoltaic cells in the solar panel reverse biases one or more photovoltaic cells in the solar panel. The reverse biasing of the one or more photovoltaic cells results in hot spot formations in the one or more photovoltaic cells. Hot-spot formation causes extensive physical damage to the solar panel. Existing systems regulate current flowing through individual photovoltaic cells and increase the power generated in the photovoltaic module. However, the existing systems are plagued with several disadvantages. Further, the existing systems lack methods to prevent hot-spot formations in the solar panel.

In one existing system, a group of photovoltaic modules are connected in series to form a solar panel. Each photovoltaic module in the group of photovoltaic modules is connected to a fly-back transformer. When current output of a photovoltaic module among the group of photovoltaic modules drop down below a threshold value, the fly-back transformer supplies the photovoltaic module with current. As a result, the net current flowing through the group of photovoltaic modules increase and as a result, power generation increases. However, in instances requiring voltage larger than the voltage generating capability of the group of photovoltaic modules in the solar panel, a plurality of solar panels is connected in series to form a string. Power generated by the string is proportional to the net voltage of the plurality of solar panels and the current flowing through the string. As a result, power generated by the string is proportional to lowest value of current generated by an individual solar panel in the string. Thus, there is a necessity for a system to increase the current output of individual solar panels in the string and thereby increase the net power generating capability of the string.

In light of the foregoing discussion there is a need for optimizing load current to achieve Maximum Power Point (MPP) in a string of solar panels. Further, there is a need for a system to increase the current output of individual solar panels in the string. Furthermore, there is a need for a combined MPPT system to optimize current in multiple solar panels so that the computational resources are shared among multiple solar panels thereby lowering the total cost. Moreover, there is a need for a system to prevent hot-spot formations in a string of solar panels. Furthermore, there is a need for a system to detect and correct hot-spot formations in the string of solar panels.

### SUMMARY

The above mentioned need for optimizing load current for MPP in a string of solar panels is met by employing a Maximum Power Point Tracking Optimizer to optimize the load current in the string of solar panels.

An example of a system for optimizing load current includes a string of solar panels. The system includes a microprocessor coupled to the string of solar panels. The microprocessor is operable to determine a peak current. The peak current corresponds to a maximum power point (MPP) of a solar panel. Further, the microprocessor measures a load current. The load current is the current flowing through the string of solar panels. The microprocessor is operable to determine a compensatory current. The compensatory current is equal to the difference between the peak current and the load current. The system includes a first DC-to-DC converter comprising input terminals coupled to a load and output terminals coupled to each solar panel in the string of solar panels. The first DC-to-DC converter is operable to supply a compensatory power for compensating a drop in the peak current arising due to shading of one or more solar panels. Moreover, the system includes a second DC-to-DC converter coupled to the first DC-to-DC converter. The second DC-to-DC converter is operable as one of a voltage adder and a voltage subtractor to generate a compensatory voltage for compensating a drop in the load current arising due to panel mismatch among the string of solar panels.

An example of a method of optimizing a load current in a string of solar panels includes determining a peak current corresponding to maximum power point (MPP) of a solar panel. Further, the method includes measuring the load current flowing through the solar panel. Furthermore, the method includes determining a compensatory current. The compensatory current is equal to the difference between the peak current and the load current. Moreover, the method includes supplying a compensatory power based on the compensatory current. The compensatory power accounts for a drop in the peak current of the solar panel. Moreover, the method includes determining a voltage to compensate for a drop in the load current flowing through the string of solar panels. Furthermore, the method includes supplying the voltage in series with the solar panel, thereby optimizing the load current in the string of solar panels.

An example of a system for optimizing load current in a string of solar panels includes a string of solar panels. The system includes a combined MPPT system coupled to the string of solar panels. Further the system includes a fly back convertor comprising input terminals coupled to a load and output terminals coupled to the string of solar panels and operable to supply a compensatory power for compensating a drop in the peak current arising due to shading of one or more photovoltaic panels.

An example of a system for preventing hot-spot formation in a string of solar panels includes a string of solar panels. Further, the system includes a microprocessor coupled to the string of solar panels. The microprocessor is operable to determine a first current, wherein the first current is minimum value of current required to prevent formation of hot-spots in the string of solar panels. Further, the microprocessor is operable to measure a load current, wherein the load current is the current flowing through the string of solar panels. Moreover, the microprocessor is operable to determine a compensatory current, wherein the compensatory current is equal to the difference between the first current and the load current. Furthermore, the system includes a first DC-to-DC converter comprising input terminals coupled to a load and output terminals coupled to each solar panel in the string of solar panels. Moreover, the system includes a second DC-to-DC converter coupled to the first DC-to-DC converter. The second DC-to-DC convertor supplies a compensatory voltage for compensating a drop in the load current arising due to panel mismatch among the string of solar panels, thereby preventing hot spot formation in the string of solar panels.

Further, features and advantages of embodiments of the present subject matter, as well as the structure and operation of preferred embodiments disclosed herein, are described in detail below with reference to the accompanying exemplary drawings.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 a block diagram of a system for optimizing load current in a string of solar panels in accordance with one embodiment of the present invention;

FIG. 2 is a flow chart illustrating a process for optimizing a load current to achieve Maximum Power Point (MPP) in a string of solar panels, in accordance with another embodiment of the present invention;

FIG. 3 illustrates a system including a solar panel with a negative voltage adder as an MPPT optimizer, in accordance with one embodiment of the present invention;

FIG. 4 illustrates a system including a solar panel with a positive voltage adder as an MPPT optimizer, in accordance with another embodiment of the present invention;

FIG. 5 is an exemplary illustration of a system including a solar panel with a buck boost switching regulator as an MPPT optimizer, in accordance with yet another embodiment of the invention;

FIG. 6 is an exemplary illustration of a system including a solar panel with a transformer as an MPPT optimizer, in accordance with one embodiment of the invention;

FIG. 7 is a circuit diagram of a system including a solar panel with a buck switching regulator as an MPPT optimizer, in accordance with one embodiment of the present invention;

FIG. 8 is a circuit diagram of a system including a solar panel with a transformer as an MPPT optimizer, in accordance with another embodiment of the present invention; and

FIG. 9 is a circuit diagram of a system using a combined maximum power point tracker (MPPT) system, in accordance with one embodiment of the present invention.

### DETAILED DESCRIPTION OF THE EMBODIMENTS

A Maximum Power point tracking (MPPT) system maintains solar panels at a maximum power point during operation. However, DC/DC convertors in the existing MPPT systems consume a fraction of power converted thereby reducing the power delivered to a load.

The MPPT optimizer disclosed in the present disclosure operate on a differential voltage between voltage across the solar panel and the voltage defined by maximum power point of the solar panel. The differential voltage is significantly lower than the voltage across the solar panel. Hence, power generated due to the differential voltage is significantly lower than power supplied by the solar panel. The DC/DC converter consumes a fraction of power generated due to the differential voltage. As a result, power loss in case of MPPT optimizer in the present invention is lesser than power loss in an MPPT system in existing systems. The MPPT optimizer disclosed in the present disclosure optimizes the current associated with the solar panel and thereby increase the power generating capability of the solar panel.

In the present disclosure, relational terms such as first and second, and the like, may be used to distinguish one entity from the other, without necessarily implying any actual relationship or order between such entities. The following detailed description is intended to provide example implementations to one of ordinary skill in the art, and is not intended to limit the invention to the explicit disclosure, as one or ordinary skill in the art will understand that variations can be substituted that are within the scope of the invention as described.

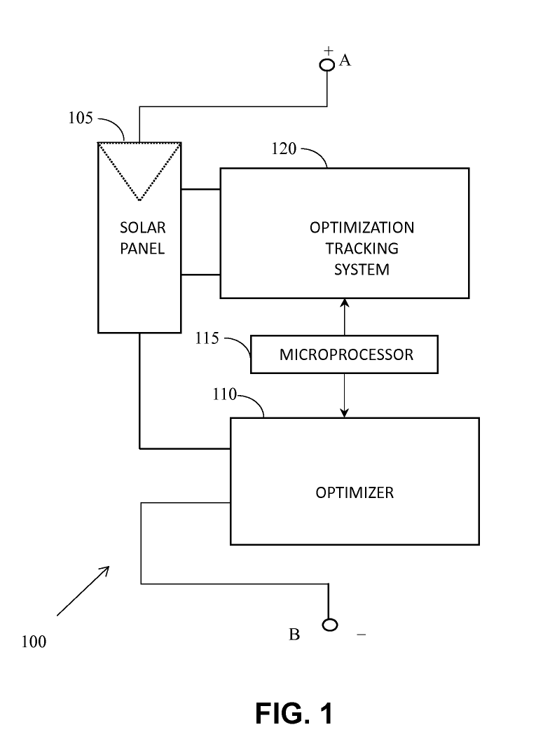

FIG. 1 is a block diagram of a system 100 for optimizing a load current in a string of solar panels in accordance with one embodiment of the present invention. In one embodiment of the present invention, the system 100 optimizes load current to achieve maximum power point in the string of solar panels. In another embodiment of the present invention, the system 100 optimizes the load current to prevent hot spot formation in the string of solar panels. In one embodiment of the present invention, the system 100 includes a solar panel 105, an optimizer 110, a microprocessor 115 and an optimization tracking system 120. The system 100 includes a positive terminal A and a negative terminal B. Several units of the system 100 are connected in series to form the string of solar panels.

### The Solar Panel

The solar panel 105 is composed of a plurality of photovoltaic modules connected in series. Examples of photovoltaic modules include but are not limited to crystalline silicon modules, rigid thin film modules, flexible thin film modules, silicon based modules and non silicon based modules.

### The Optimization Tracking System

The optimization tracking system 120 includes a fly-back transformer. The fly-back transformer includes a primary winding and a plurality of secondary windings. The primary winding is connected in parallel to the solar panel 105. Each of the secondary winding among the plurality of secondary windings is connected to a different photovoltaic module in the solar panel 105. The fly-back transformer includes a first switch and a second switch. The first switch and the second switch are controlled by the microprocessor 115.

### The Optimizer

The optimizer 110 is a DC/DC convertor. Examples of DC/DC convertor include but are not limited to buck boost regulators, charge pumps, and switching regulators. The DC/DC converter includes a third switch and a fourth switch. The third switch and the fourth switch are controlled by the microprocessor 115.

### Working of the System

The solar panel 105 converts solar energy into electrical energy. The solar panel 105 is composed of a plurality of photovoltaic modules connected in series. Voltages across the plurality of photovoltaic modules in the solar panel 105 add up to generate a first voltage across the solar panel 105. Further, lowest value of current generated by a photovoltaic module in the solar panel 105 flows through the solar panel 105 as the load current. Power generated by the solar panel 105 is the product of the first voltage and the load current.

The microprocessor 115 and the optimization tracking system 120 function together to increase power generated by the solar panel 105 by increasing the load current through the photovoltaic module to a peak current. In one embodiment of the present invention, the peak current corresponds to Maximum Power Point (MPP) of the photovoltaic module. In another embodiment of the present invention, the peak current is minimum current required in the string of solar panels to prevent hot-spot formation. To increase the load current to the peak current, the microprocessor 115 measures the load current flowing through the solar panel 105. Further, the microprocessor 115 uses the first switch and the second switch to determine the peak current. In one embodiment of the present invention, the microprocessor 115 measures voltages across multiple solar panels on the string of solar panels to identify potential hot-spots. Further, the microprocessor 115 calculates the value of the peak current based on the identification. Moreover, the microprocessor detects hot-spots present in the string of solar panels. Moreover, the microprocessor 115 determines the difference between the peak current and the load current. The optimization tracking system 120 supplies a compensatory current equal to the difference between the peak current and the load current to the terminals of the photovoltaic module. As a result, the load current through the solar panel 105 increases and power generation occurs in the solar panel 105 at maximum efficiency. However, to supply the compensatory current, the optimization tracking system 120 supplies a compensatory power based on the compensatory current to the photovoltaic module. The MPPT system 120 derives the compensatory power from the solar panel 105. Loss of power due to compensation of the photovoltaic module results in a drop in a first current corresponding to the MPP of the solar panel 105. The first current flows through the solar panel 105 as the load current. The first current is lower than a second current corresponding to the peak current. As a result, the load current flowing through the string of solar panels is lower than the second current.

Power generated by the string is the product of the voltage across the string and the load current. As a result, power generation in the string increases if the load current is increased to the peak current. In one embodiment of the present invention, hot-spot formation in the string is prevented if the load current increases to the peak current. The optimizer 110 and the microprocessor 115 function together to increase power generation in the string. To increase power generation, the optimizer 110 and the microprocessor 115 increase the load current flowing through the string of solar panels to the peak current. To increase the load current, the microprocessor 115 measures the load current flowing through the solar panel 105. Further, the microprocessor 115 measures the first voltage across the solar panel 105. Moreover, the microprocessor 115 determines a second voltage. When voltage across the terminal A and terminal B is equal to the second voltage, the second current flows through the system 100 as the load current. The microprocessor 115 use the third switch and the fourth switch to determine the second voltage. Furthermore, the microprocessor 115 determines a third voltage equal to the difference between the first voltage and the second voltage. The third voltage is negative in polarity. The optimizer 110 supplies the third voltage in series with the solar panel 105. In effect, the optimizer 110 acts as a voltage subtractor to compensate for a drop in the load current flowing through the solar panel 105. Hence, the optimizer 110 raises the load current flowing through the string of solar panels to the second current. In one embodiment of the present invention, the optimizer 110 optimizes the load current to achieve Maximum Power Point in the string of solar panels. In another embodiment of the present invention, the optimizer 110 optimizes the load current to prevent hot-spot formations in the string of solar panels. In yet another embodiment of the present invention, the optimizer 110 optimizes the load current to correct hot-spot formations in the string of solar panels.

In one embodiment of the present invention, the optimizer 110 optimizes a load current within a photovoltaic module to achieve Maximum Power point for a plurality of photovoltaic cells connected in series in the photovoltaic module. Hence, the present invention enables intra-module Maximum Power Point (MPP) optimization in the photovoltaic module. In another embodiment of the present invention, the optimizer 110 optimizes a load current within a photovoltaic module to prevent hot-spot formation in a plurality of photovoltaic cells connected in series in the photovoltaic module. Hence, the present invention prevents intra-module hot spot formation in the photovoltaic module.

In another embodiment of the present invention, the optimization tracking system 120 is a first DC-to-DC converter. The first DC-to-DC converter includes input terminals coupled to a load and output terminals coupled to each solar panel in a string of solar panels. The DC-to-DC converter is operable to supply a compensatory power for compensating a drop in a peak current arising due to shading of one or more solar panels in the string of solar panels. The first DC-to-DC converter includes a 4:1 transformer. The 4:1 transformer includes a primary coil coupled to the load via one or more switches and a secondary coil configured as four electrically isolated outputs. Each of the four electrically isolated outputs includes a capacitor and a diode switch. Each of the four electrically isolated outputs is coupled to the solar panel 105.

Further, the optimizer 110 is a second DC-to-DC converter coupled to the first Dc-to-DC converter. The second DC-to-DC converter is operable as one of a voltage adder and a voltage subtractor. The second DC-to-DC converter generates a compensatory voltage for compensating a drop in a load current arising due to panel mismatch among the string of solar panels. The second DC-to-DC converter adds a negative voltage in series to a voltage across the string of solar panels, if voltage across the string of solar panels Vₛₒₗₐᵣₚₐₙₑₗ is greater than voltage V_{load} across the load. The second DC-to-DC converter adds a positive voltage in series to the voltage across the string of solar panels, if voltage across the string of solar panels Vₛₒₗₐᵣₚₐₙₑₗ is lesser than voltage V_{load} across the load.

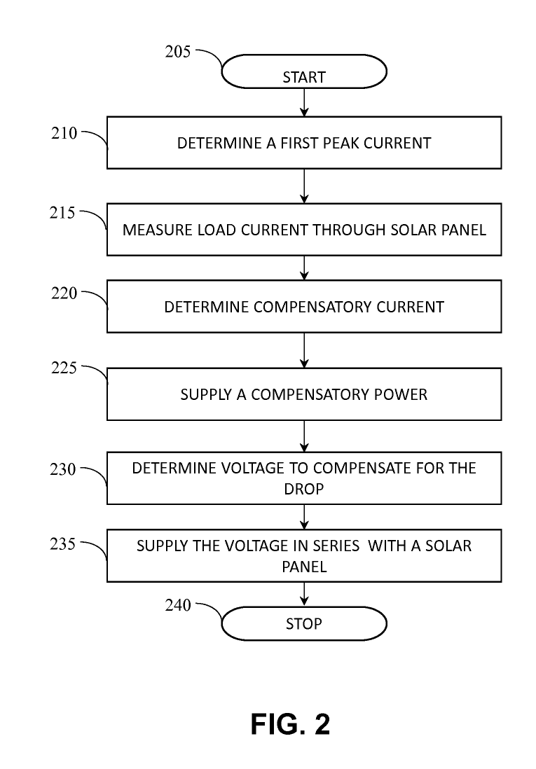

FIG. 2 is a flowchart illustrating a process for optimizing a load current to achieve Maximum Power Point (MPP) in a string of solar panels, in accordance with one embodiment of the present invention. A solar panel includes a plurality of photovoltaic modules. The process begins at step 205.

At step 210, a microprocessor determines a peak current corresponding to Maximum Power Point of a photovoltaic module within a solar panel. The microprocessor controls a Maximum Power Point Tracking (MPPT) system connected to the solar panel and the photovoltaic module in order to determine the peak current. The microprocessor follows an MPPT algorithm to determine the peak current.

At step 215, the microprocessor measures the load current flowing through the photovoltaic module. The load current flows through the solar panel.

At step 220, the microprocessor determines a compensatory current equal to the difference between the peak current and the load current. Further, the microprocessor instructs the MPPT system to generate a compensatory power based on the compensatory current.

At step 225, the MPPT system supplies the compensatory power to the photovoltaic module, thereby supplying the compensatory current to cause the load current to increase to the peak current. However, the MPPT system derives power from the solar panel to generate the compensatory power. A first current, corresponding to MPP of the solar panel, drops because of power consumed to generate the compensatory power. The load current in the solar panel is equal to the first current. The first current is lower than a second current corresponding to the MPP of the string of solar panels. The load current in the solar panel is equal to the first current. When the solar panel is connected in series to the string of solar panels, the solar panel causes the first current to flow through the string as the load current. Hence, the load current flowing through the string of solar panels is lower than the second current. Power generated by the string when the first current flows as the load current is lower than the power generated by the string when the second current flows as the load current.

At step 230, the microprocessor determines a voltage to compensate for the drop in the first current. The voltage, when connected in series with the solar panel, causes the second current to flow through the solar panel as the load current. The MPPT optimizer generates the voltage in a DC/DC converter.

At step 235, the MPPT optimizer supplies the voltage in series with the solar panel. As a result, the third peak current flows through the system as the load current. Hence, the MPPT optimizer optimizes the load current to achieve MPP in the string of solar panels.

The process ends at step 240.

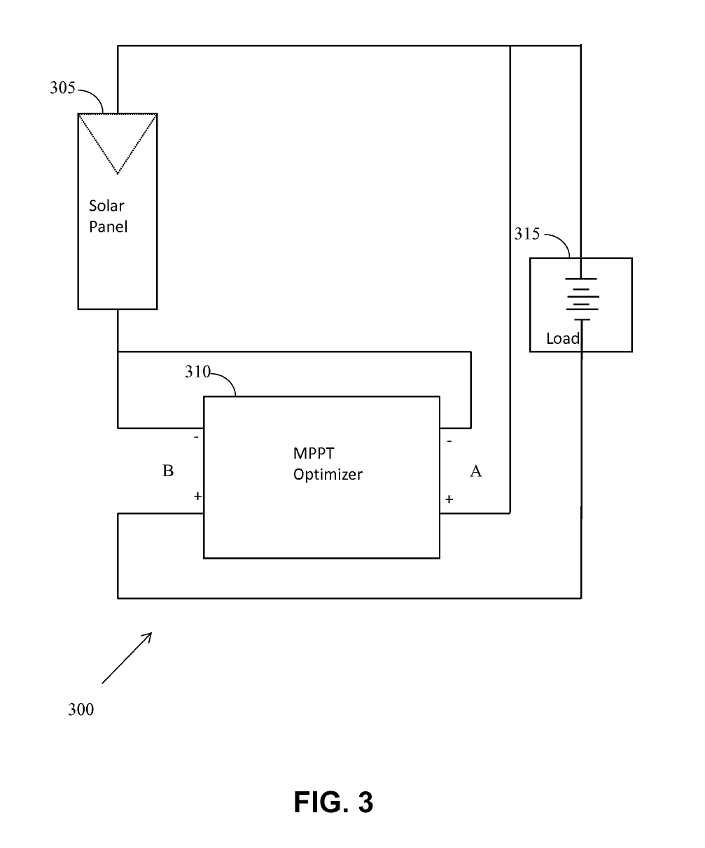

FIG. 3 illustrates a system 300 including a solar panel 305 with a negative voltage adder as a Maximum Power Point Tracking (MPPT) optimizer 310 according to one embodiment of the present invention. The system 300 includes the solar panel 305, the MPPT optimizer 310 and a load 315 connected in series. The solar panel 305 includes a plurality of photovoltaic modules connected in series.

The load 315 requires a first current for proper functioning. However, the first current is higher than a load current generated by the solar panel 305. The MPPT optimizer 310 increases the load current flowing through the system 300 to be equal to the first current.

The MPPT optimizer 310 is a DC/DC convertor. Examples of DC/DC convertor include but are not limited to buck boost regulators, charge pumps, and switching regulators. The MPPT optimizer 310 includes an input terminal A and an output terminal B. The input terminal A feeds a first voltage across the solar panel 305 to the MPPT optimizer 310. An external microprocessor determines a second voltage. If the second voltage is applied across the load 315, the load current flowing through the system 300 becomes equal to the first current. Further, the external microprocessor calculates a third voltage. The third voltage is equal to the difference between the first voltage and the second voltage. The external microprocessor transmits information regarding the third voltage to the MPPT optimizer 310. The MPPT optimizer 310 generates the third voltage at the output terminal B. The third voltage at the output terminal has negative polarity. Further, the output terminal B is in series connection with the solar panel 305. The third voltage at the output terminal B adds to the first voltage to decrease the voltage across the load 315 to the second voltage. As a result, the load current flowing through the system 300 increases to the first current.

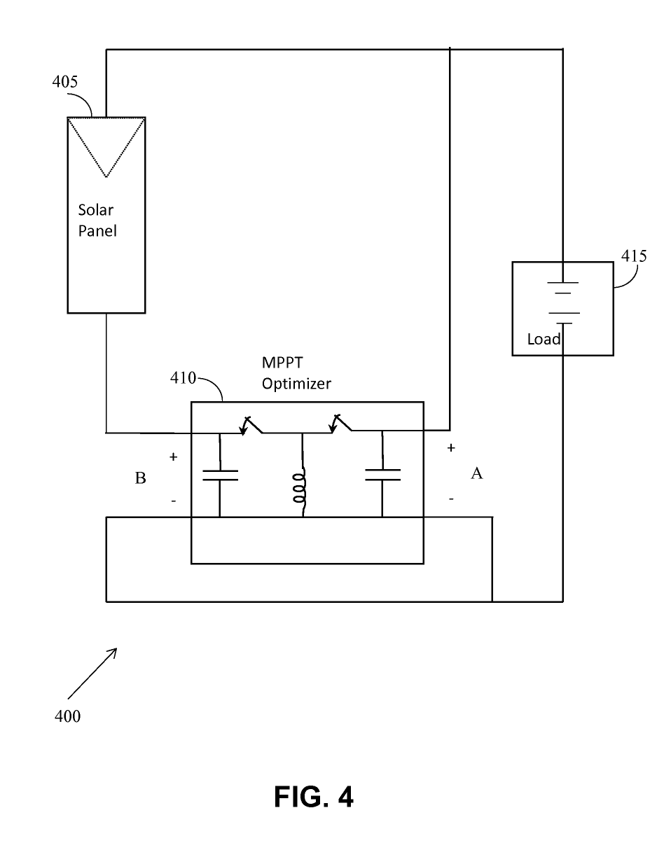

FIG. 4 illustrates a system 400 including a solar panel 405 with a positive voltage adder as a Maximum Power point tracking (MPPT) optimizer 410 according to one embodiment of the present invention. The solar panel 405 includes a plurality of photovoltaic modules. Further, the system 400 includes a load 415. A photovoltaic module includes a plurality of photovoltaic cells. The plurality of photovoltaic cells is interconnected in series and parallel connection.

The load 415 in the system 400 requires a first current for proper functioning. However, the first current is lower than a load current generated by the solar panel 405. The MPPT optimizer 410 reduces the load current flowing through the system 400 to be equal to the first current. The MPPT optimizer 410 is a DC/DC convertor. Examples of DC/DC convertor include but are not limited to buck boost regulators, charge pumps, and switching regulators.

In one embodiment of the present invention, the DC/DC converter is a buck boost switching regulator. The MPPT optimizer 410 includes an input terminal A and an output terminal B. An external microprocessor measures a first voltage across the solar panel 405. The input terminal A feeds a second voltage across the load 415 to the MPPT optimizer 410. The second voltage is the voltage required across the load 415, to make the load current equal to the first current. Further, the external microprocessor calculates a third voltage. The third voltage is equal to the difference between the first voltage and the second voltage. The external microprocessor transmits information regarding the third voltage to the MPPT optimizer 410. The MPPT optimizer 410 generates the third voltage at the output terminal B. The third voltage at the output terminal has positive polarity. Further, the output terminal B is in series connection with the solar panel 405. The third voltage adds to the first voltage in order to increase the voltage across the load 415 to the second voltage. As a result, the load current flowing through the system 400 increases to the first current.

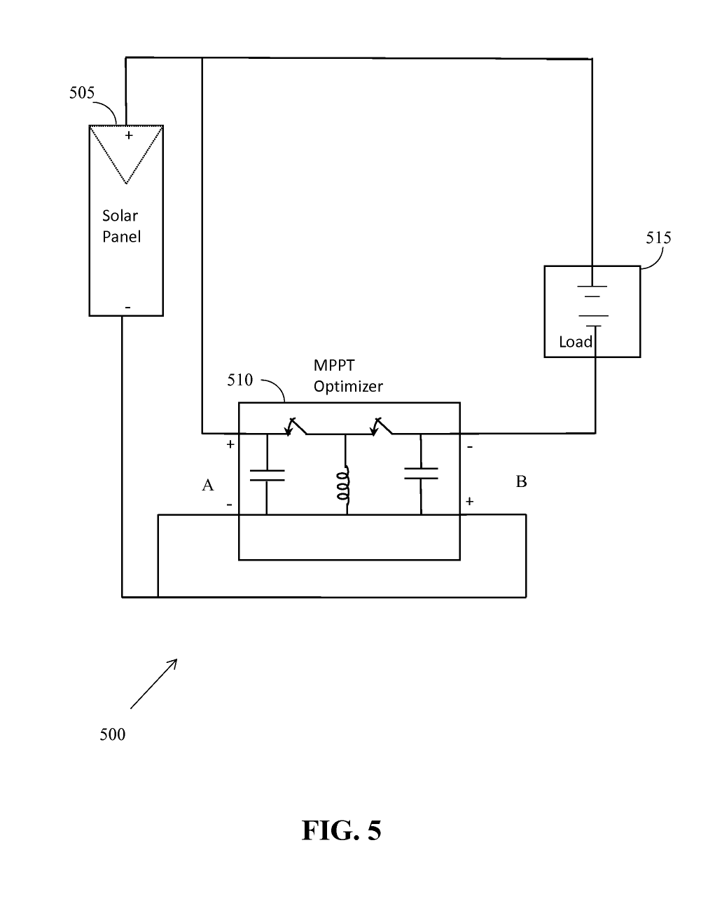

FIG. 5 illustrates a system 500 including a solar panel 505 with a buck boost switching regulator as a Maximum Power point tracking (MPPT) optimizer 510 in accordance with one embodiment of the present invention. The system 500 includes the solar panel 505, the MPPT optimizer 510 and a load 515 connected in series. The solar panel 505 includes a plurality of photovoltaic modules. A photovoltaic module includes a plurality of photovoltaic cells. The plurality of photovoltaic cells is interconnected in series and parallel connection. The solar panel 505 generates power at maximum efficiency at maximum power point (MPP).

The load 515 in system 500 requires a first current for proper functioning. However, the first current is higher than current generated by the solar panel 505. The MPPT optimizer 510 causes a load current flowing through the system 500 to be equal to the first current. The MPPT optimizer 510 is a DC/DC convertor. Examples of DC/DC convertor include but are not limited to buck boost regulators, charge pumps, and switching regulators.

In one embodiment of the present invention, the DC/DC converter is a buck boost switching regulator. The MPPT optimizer 510 includes an input terminal A and an output terminal B. The input terminal A feeds a first voltage across the solar panel 505 to the MPPT optimizer 510. An external microprocessor determines a second voltage. If the second voltage is applied across the load 515, the load current flowing through the system 500 becomes equal to the first current. Further, the external microprocessor calculates a third voltage. The third voltage is equal to the difference between the first voltage and the second voltage. The external microprocessor transmits information regarding the third voltage to the MPPT optimizer 510. The MPPT optimizer 510 generates the third voltage at the output terminal B. The third voltage at the output terminal has negative polarity. Further, the output terminal B is in series connection with the solar panel 505. The third voltage adds to the first voltage to cause the voltage across the load 515 to be equal to the second voltage. As a result, the load current flowing through the system 500 is increased to the first current.

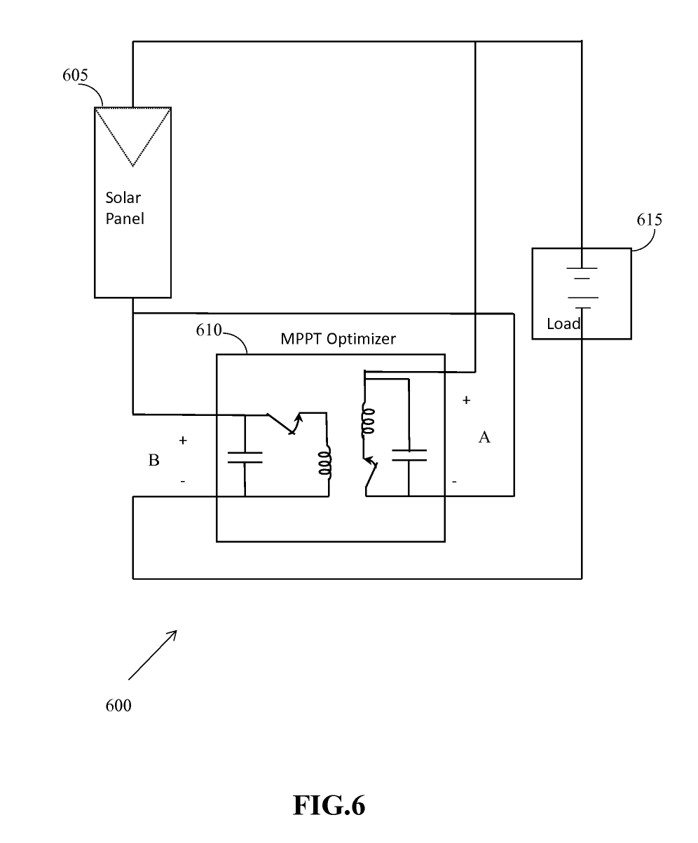

FIG. 6 illustrates a system 600 including a solar panel 605 with a transformer as a Maximum Power point tracking (MPPT) optimizer 610 in accordance with another embodiment of the present invention. The system 600 includes the solar panel 605, the MPPT optimizer 610 and a load 615. The solar panel 605 includes a plurality of photovoltaic modules. A photovoltaic module includes a plurality of photovoltaic cells. The plurality of photovoltaic cells is interconnected in series and parallel connection. The solar panel 605 generates power at maximum efficiency at maximum power point (MPP) of the solar panel 605.

The load 615 requires a first current for proper functioning. However, the first current is different from a load current generated by the solar panel 605. The MPPT optimizer 610 causes the load current flowing through the system 600 to be equal to the first current. The MPPT optimizer 610 is a DC/DC convertor. Examples of DC/DC convertor include but are not limited to buck boost regulators, charge pumps, and switching regulators.

In one embodiment of the present invention, the DC/DC converter is a fly-back transformer. The MPPT optimizer 610 includes an input terminal A and an output terminal B. The input terminal A feeds a first voltage across the solar panel 605 to the MPPT optimizer 610. An external microprocessor determines a second voltage. If the second voltage is applied across the load 615, the load current becomes equal to the first current. Further, the external microprocessor calculates a third voltage. The third voltage is equal to the difference between the first voltage and the second voltage. The external microprocessor transmits information regarding the third voltage to the MPPT optimizer 610. The MPPT optimizer 610 generates the third voltage at the output terminal B. Further, the output terminal B is in series connection with the solar panel 605. Voltage across the load 615 changes as the voltage across the output terminal B varies in magnitude. The third voltage at the output terminal B adds to the first voltage across the solar panel 605 to change voltage across the load 615 to the second voltage. As a result, the load current flowing through the system 600 increases to the first current.

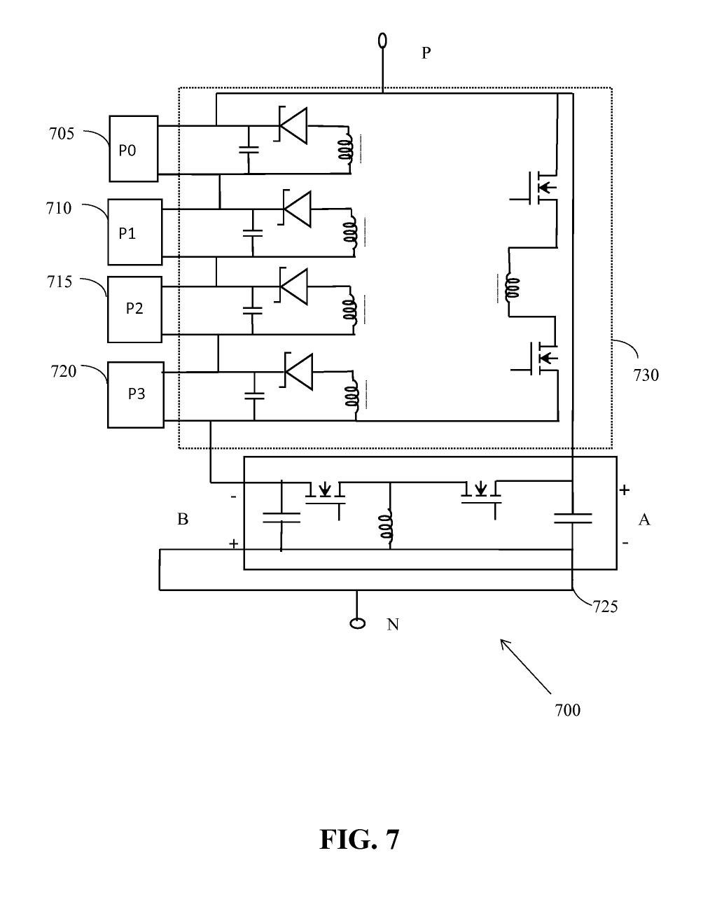

FIG. 7 is a circuit diagram of a system 700 including a solar panel with buck switching regulator as an MPPT optimizer 725, in accordance with one embodiment of the present invention. The solar panel includes a plurality of photovoltaic modules 705, 710, 715, and 720 connected in series. The plurality of photovoltaic modules 705, 710, 715, and 720 includes a first photovoltaic module (P0) 705, a second photovoltaic module (P1) 710, a third photovoltaic module (P2) 715, and a fourth photovoltaic module (P3) 720. The system 700 includes a positive terminal P and a negative terminal N. Multiple units of system 700 are connected in series to form a string of solar panels. Shading in individual photovoltaic modules in the solar panel cause different photovoltaic modules to generate different values of currents. Differences in values of current generated cause mismatches between individual photovoltaic modules.

An MPPT optimization circuit provides distributed MPPT optimization for the solar panel. The MPPT optimization circuit includes the MPPT optimizer 725 and a fly-back transformer 730. The fly-back transformer 730 acts as a distributed MPPT system. The fly-back transformer 730 compensates for reduction in current generation in individual photovoltaic modules among the plurality of photovoltaic modules 705, 710, 715, and 720 by supplying compensatory power. However, the fly-back transformer 730 derives compensatory power from the solar panel. As a result, the fly-back transformer 730 causes a drop in a first current corresponding to Maximum Power Point of the solar panel. As a result, the load current, being equal to the first current, is lower than a second current corresponding to MPP of the string.

The MPPT optimizer 725 is a DC/DC convertor. Examples of DC/DC convertor include but are not limited to buck boost regulators, charge pumps, and switching regulators. In one embodiment of the present invention, the MPPT optimizer 725 is a buck boost switching regulator. The MPPT optimizer 725 includes an input terminal A and an output terminal B. The input terminal A feeds a first voltage across the solar panel to the MPPT optimizer 725. An external microprocessor determines the second current. Further, the external microprocessor determines a second voltage. If the second voltage is applied across the terminal P and the terminal N, the second current flows though system 700 as the load current. The MPPT optimizer 725 generates a third voltage at the output terminal B. The third voltage is equal to the difference between the first voltage and the second voltage. The third voltage adds to the first voltage and causes the voltage across terminals P and N to be equal to the second voltage. As a result, the second peak current flows through the system 700 as the load current. As a result, the MPPT optimizer 725 optimizes power generation in solar panels.

In one exemplary illustration of the present invention, the first photovoltaic module P0 705 generates 5 amperes (A) and 10 volts (V), and a group of photovoltaic modules 710, 715, and 720 generate 10 A and 10 volts (V) each. Voltage across the system 700 is 40 V. The plurality of photovoltaic modules 705, 710, 715, and 720 are connected in series. As a result, the plurality of photovoltaic modules 705, 710, 715, 720 is forced to carry 5 A and hence power generated is low. The fly-back transformer 730 supplies 5 A at 10 V to the first photovoltaic module P0 705. The fly-back transformer 730 effectively delivers 50 Watts of power to the first photovoltaic module P0 705, thereby increasing the current through the first photovoltaic module 705 to 10 A. However, the fly-back transformer 730 derives the 50 watts of power from the solar panel. Hence, the load current flowing through the solar panel reduces to 8.75 A. Thus, the plurality of photovoltaic modules 705, 710, 715, 720 carry 8.75 A and the power generated increases. The system 700 causes a mismatch when connected in series with a string of solar panels where each solar panels in the string generates 10 A. To alleviate the mismatch, the MPPT optimizer 725 supplies a negative voltage of 5 V in series with voltage across the plurality of photovoltaic modules 705, 710, 715, and 720. The addition of −5 V causes the voltage across system 700 to drop to 35 V, thereby increasing current flowing through the system 700 to 10 A. As a result, the MPPT optimizer 725 alleviates the mismatch in the string.

In one embodiment of the present invention, the fly back transformer 730 is referred as a first DC-to-DC converter. The first DC-to-DC converter includes input terminals coupled to a load and output terminals coupled to each solar panel in a string of solar panels. The DC-to-DC converter is operable to supply a compensatory power for compensating a drop in a peak current arising due to shading of one or more solar panels in the string of solar panels. The first DC-to-DC converter includes a 4:1 transformer. The 4:1 transformer includes a primary coil coupled to the load via one or more switches and a secondary coil configured as four electrically isolated outputs. Each of the four electrically isolated outputs includes a capacitor and a diode switch. Each of the four electrically isolated outputs is coupled to the solar panel.

Further, the MPPT optimizer 725 is a second DC-to-DC converter coupled to the first Dc-to-DC converter. The second DC-to-DC converter is operable as one of a voltage adder and a voltage subtractor. The second DC-to-DC converter generates a compensatory voltage for compensating a drop in a load current arising due to panel mismatch among the string of solar panels. The second DC-to-DC converter adds a negative voltage in series to a voltage across the string of solar panels, if voltage across the string of solar panels Vₛₒₗₐᵣₚₐₙₑₗ is greater than voltage V_{load} across the load.

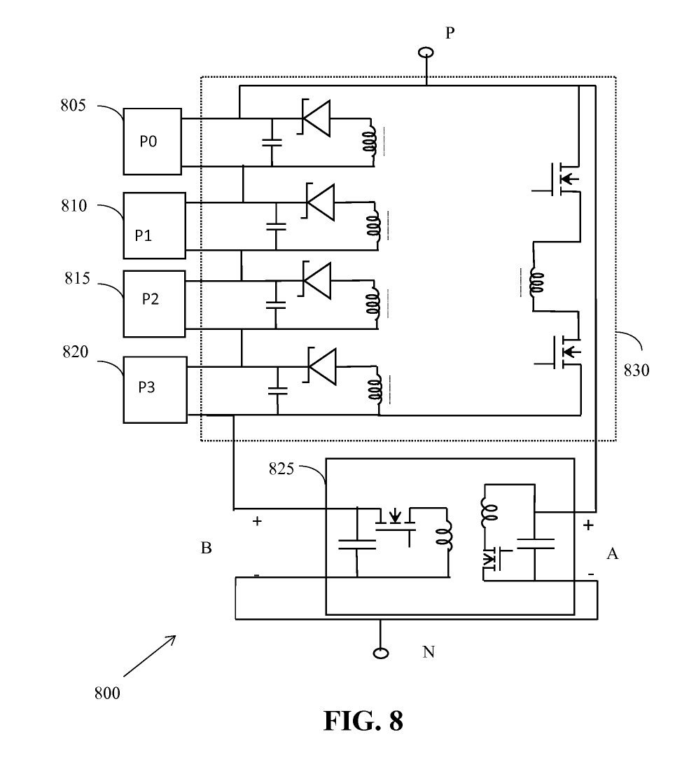

FIG. 8 is a circuit diagram of a system 800 including a solar panel with a transformer as an MPPT optimizer 825, in accordance with one embodiment of the present invention. The solar panel includes a plurality of photovoltaic modules 805, 810, 815, and 820 connected in series. The plurality of photovoltaic modules 805, 810, 815, and 820 includes a first photovoltaic module (P0) 805, a second photovoltaic module (P1) 810, a third photovoltaic module (P2) 815, and a fourth photovoltaic module (P3) 820. The system 800 includes a positive terminal P and a negative terminal N. Multiple units of system 800 are connected in series to form a string of solar panels. Shading in individual photovoltaic modules in the solar panel cause different photovoltaic modules to generate different values of currents. Difference in value of current generated cause mismatches between individual photovoltaic modules.

An MPPT optimization circuit provides distributed MPPT optimization for the solar panel. The MPPT optimization circuit includes the MPPT optimizer 825 and a fly-back transformer 830. The fly-back transformer 830 acts as a distributed MPPT system. The fly-back transformer 830 compensates for reduction in current generation in individual photovoltaic modules among the plurality of photovoltaic modules 805, 810, 815, and 820 by supplying compensatory power. However, the fly-back transformer 830 derives compensatory power from the solar panel. As a result, the fly-back transformer 830 causes a change in a first current corresponding to Maximum Power Point of the solar panel. As a result, the load current, being equal to the first current, is lower than a second current corresponding to MPP of the string.

The MPPT optimizer 825 is a DC/DC convertor. Examples of DC/DC convertor include but are not limited to buck boost regulators, charge pumps, and switching regulators. In one embodiment of the present invention, the MPPT optimizer 825 is a transformer. The MPPT optimizer 825 includes an input terminal A and an output terminal B. The input terminal A feeds a first voltage across the solar panel to the MPPT optimizer 825. An external microprocessor determines the second current. Further, the external microprocessor determines a second voltage. If the second voltage is applied across the terminal P and the terminal N, the second current flows though system 800 as the load current. The MPPT optimizer 825 generates a third voltage at the output terminal B. The third voltage is equal to the difference between the first voltage and the second voltage. The third voltage adds to the first voltage and causes the voltage across terminals P and N to be equal to the second voltage. As a result, the second peak current flows through the system 800 as the load current. As a result, the MPPT optimizer 825 optimizes power generation in solar panels.

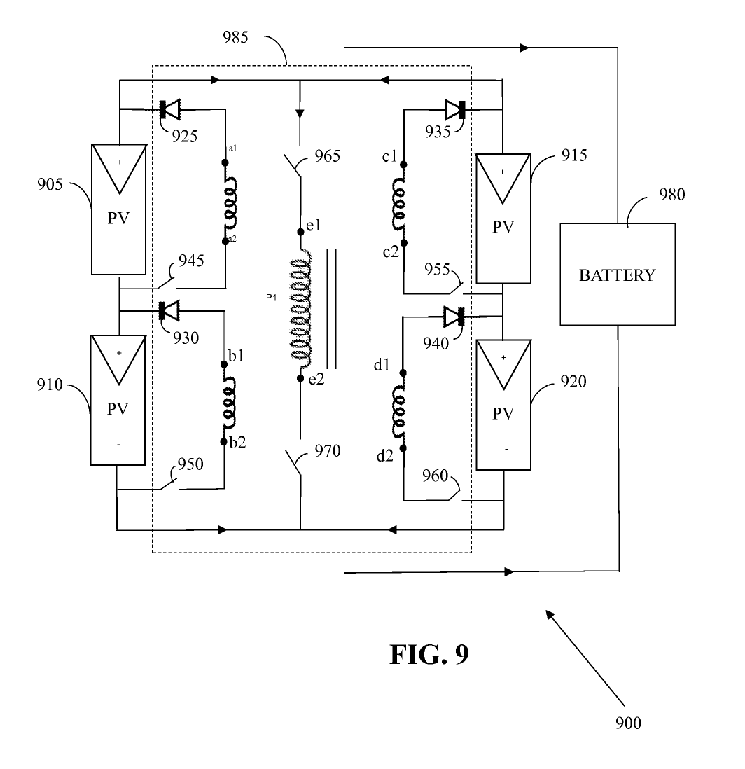

Typically, while implementing the MPPT optimizer 825 in a string of solar panels, multiple optimizers will be placed in close proximity. It is desired to combine these optimizers so as to share resources and thereby reduce the overall cost. In one embodiment of the present invention, an MPPT optimization circuit provides combined MPPT optimization for the string of solar panels. FIG. 9 depicts a system 900 for optimizing load current in a string of solar panels using a combined maximum power point tracker (MPPT) configuration. The combined MPPT configuration includes a plurality of photovoltaic modules 905, 910, 915, and 920. The plurality of photovoltaic modules 905, 910, 915, and 920 are electrically connected with a fly back convertor 985. Further, the system 900 includes a plurality of diodes 925, 930, 935, and 940, a plurality of switches 945, 950, 955, and 960 and a battery 980.

In one exemplary illustration of the present invention, photovoltaic panels 905 and 910 form a first serially connected string. Photovoltaic panels 915 and 920 form a second serially connected string. The first serially connected string and the second serially connected string are connected in parallel to enable higher current output. Diodes 925, 930, 935, and 940 are provided to prevent a reverse current from flowing through the plurality of photovoltaic panels 905, 910, 915, and 920.

Shading in individual photovoltaic modules in the string of solar panels cause drop in current in the corresponding photovoltaic modules. Consider for example, the photovoltaic panels 905, 910, and 915 generate 30 volts (V) and 5 amperes (A) each, and the photovoltaic panel 920, because of shading generates 20V and 5 A. Hence the first serially connected string of photovoltaic panels 905 and 910 generate a combined 60V and the second serially connected string of photovoltaic panels 915 and 920 generate a combined 50V. Due to mismatch in the voltage generated, no power is delivered to the battery 980.

The primary coil of the transformer 985 supplies 10V required to balance the photovoltaic panel 920. A varying current in the transformer's primary winding, e1 to e2 creates a varying magnetic flux in the core and a varying magnetic field impinging on the secondary winding. The varying magnetic field at the secondary induces a varying electromotive force (emf) or voltage in the secondary winding, d1 to d2. As a result, the voltage generated across the photovoltaic module 920 increases to 30V and the plurality of photovoltaic panels 905, 910, 915, and 920 generates maximum power. A current measuring unit measures current flowing through each of the plurality of photovoltaic modules 905, 910, 915, and 920. The value of the current measured is adjusted by the combined MPPT to operate each of the plurality of photovoltaic modules 905, 910, 915, and 920 at the maximum power point.

Further, the combined MPPT configuration regulates the output current of the solar panel delivered to the battery. The regulation of the output by the combined MPPT configuration eliminates the use of a charge controller in the solar panel. The elimination of the use of the charge controller is achieved by an intelligent algorithm. The state of charge (SOC) of the battery 980 is monitored by computing the data accumulated. Based on the SOC of the battery 980 and the battery voltage, the algorithm determines maximum charging current of the battery 980. Furthermore, the combined MPPT configuration regulates the output current delivered to the battery 980 based on the charging current constraint, thereby eliminating the need of a charge controller.

In one embodiment of the invention, the combined MPPT configuration can be used in combination with the inbuilt charge controller, in order to increase the efficiency of the inbuilt charge controller. In most cases, the inbuilt charge controller is a PWM controller. The PWM controller fall short to optimize the power transfer when input voltage delivered to the inverter is reduced. The loss of efficiency can be compensated by combining the PWM charge controller with the combined MPPT configuration. The combined MPPT configuration provides a voltage boost to match for the charge required by the invertor for charging the battery.

The system 900 also includes a monitoring device and a surge protection device. The monitoring device monitors the various parameters in each of the plurality of photovoltaic modules 905, 910, 915, and 920. The monitoring device includes various components such as a temperature sensor, a voltage measurement unit, a current measurement unit, a microcontroller, a memory and a communication unit. The temperature sensor senses the temperature of each PV module. Based on the value of temperature measured, an optimal cooling system is provided for the system 900. The current measuring unit measures current flowing through each PV modules. The value of the current measured is adjusted by the combined MPPT to operate the PV modules at the maximum power point. Further, the current measuring unit measures charging current and discharging current of the battery. The voltage measuring unit measures the battery voltage. The battery voltage, charging current, and discharging current provide an indication of the battery health. On identifying the battery health, proper maintenance can be provided.

Further, the monitoring device measures a plurality of inverter parameters. The inverter parameters identifies inverter and grid usage pattern. Furthermore, the monitoring device measures the grid parameters including but not limited to power consumed and power factor. The grid parameters measured is utilized to reduce the downtime by providing alerts during underperformance of electronic components of the system 900.

The monitoring device communicates with a remote monitoring device the measured parameters of the plurality of the photovoltaic modules 905, 910, 915, and 920. The combined MPPT optimization circuit allows the sharing of the computing resources in the monitoring device among the plurality of the photovoltaic modules 905, 910, 915, and 920. The sharing of the computing resources significantly reduces the complexity of the solar panel.

Further, the combined MPPT system includes a surge protection device. The surge protection device protects the components of the system 900 from power surges and voltage spikes. Surge protection devices divert the excess voltage and current from transient or surge into grounding wires. The use of surge protection device in the combined MPPT system eliminates the need of an extra combiner box in the system 900, thereby reducing the cost for solar powered systems.

Advantageously the embodiments specified in the present invention increases the power generating capability of solar panels. Unlike the existing prior arts, the present invention reduces the power losses by optimizing a load current associated with solar panels. The present invention reduces power losses incurred by the use of DC/DC converters in parallel by connecting the DC/DC converters in series with the solar panel. The present invention provides for inter-panel Maximum Power Point (MPP) optimization among a plurality of solar panels and intra-panel MPP optimization among a plurality of photovoltaic cells. Further, the present invention enables optimization of the load current in a string of solar panels with distributed MPP optimizers. The sharing of the computational resources among the PV modules significantly reduces the cost of the solar panel. The configuration in the present invention enables the replacement of the combiner boxes in the solar system. The replacement is obtained by adding additional features such as surge protection devices, combined MPPT configuration and power generation monitoring. Further, the present invention prevents the formation of hot-spots in solar panels. Further, the present invention detects the presence of hot-spots in solar panels and corrects the hot-spot formation.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

What is claimed is:

1. A system for optimizing load current in a string of solar panels, the system comprising:
a string of solar panels;
a microprocessor coupled to the string of solar panels and operable to:
determine a peak current, wherein the peak current corresponds to a maximum power point (MPP) of a solar panel;
measure a load current, wherein the load current is the current flowing through the string of solar panels; and
determine a compensatory current, wherein the compensatory current is equal to the difference between the peak current and the load current;
a first DC-to-DC converter comprising input terminals coupled to a load and output terminals coupled to each solar panel in the string of solar panels and operable to supply a compensatory power for compensating a drop in the peak current arising due to shading of one or more solar panels; and
a second DC-to-DC converter coupled to the first Dc-to-DC converter and operable as one of a voltage adder and a voltage subtractor to generate a compensatory voltage for compensating a drop in the load current arising due to panel mismatch among the string of solar panels.

2. The system as claimed in claim 1, wherein the first DC-to-DC converter and the second DC-to-DC converter each are one of:
a fly back converter; and
a buck boost converter.

3. The system as claimed in claim 1, wherein the second DC-to-DC converter adds a negative voltage in series to a voltage across the string of solar panels, if the voltage across the string of solar panels Vₛₒₗₐᵣₚₐₙₑₗ is greater than a voltage across a battery V_{load}.

4. The system as claimed in claim 1, wherein the second DC-to-DC converter adds a positive voltage in series to a voltage across the string of solar panels, if the voltage across the string of solar panels Vₛₒₗₐᵣₚₐₙₑₗ is lesser than a voltage across a battery V_{load}.

5. The system as claimed in claim 1, wherein the first DC-to-DC converter comprises a 4:1 transformer, the 4:1 transformer comprising a primary coil coupled to the load via one or more switches and a secondary coil configured as four electrically isolated outputs.

6. The system as claimed in claim 5, wherein each of the four electrically isolated outputs comprises a capacitor and a diode switch, and each of the four electrically isolated outputs is coupled to a solar panel.

7. A method of optimizing a load current in a string of solar panels, the method comprising:
determining a peak current corresponding to a maximum power point (MPP) of a solar panel;
measuring the load current flowing through the solar panel;
determining a compensatory current, wherein the compensatory current is equal to the difference between the peak current and the load current;
supplying a compensatory power based on the compensatory current, wherein the compensatory power accounts for a drop in the peak current of the solar panel;
determining a voltage to compensate for a drop in the load current flowing through the string of solar panels; and
supplying the voltage in series with the solar panel, thereby optimizing the load current in the string of solar panels.

8. The method as claimed in claim 7, wherein the compensatory power is supplied by a first DC-to-DC converter.

9. The method as claimed in claim 7, wherein the voltage in series is supplied by a second DC-to-DC converter.

10. A system for optimizing load current in a string of solar panels, the system comprising:
a string of solar panels;
a combined MPPT system coupled to the string of solar panels; and
a fly back convertor comprising input terminals coupled to a load and output terminals coupled to the string of solar panels and operable to supply a compensatory power for compensating a drop in the peak current arising due to shading of one or more photovoltaic panels.

11. The system as claimed in claim 10, further comprising a monitoring device to measure a plurality of parameters of the string of solar panels.

12. The system as claimed in claim 11, wherein the monitoring device is operable to:
measure parameters of the one or more photovoltaic panels, wherein the parameters are at least one of but not limited to temperature, voltage, and current;
measure a plurality of invertor parameters; and
measure grid parameters, wherein the grid parameters include but are not limited to power consumed and power factor.

13. The system as claimed in claim 10, further comprising a communication module to transfer the plurality of parameters to a remote monitoring device.

14. The system as claimed in claim 10, further comprising a surge protection device to protect the plurality of solar panels from at least one of power surges and voltage spikes.

15. A system for preventing hot-spot formation in a string of solar panels, the system comprising:
a string of solar panels;
a microprocessor coupled to the string of solar panels and operable to:
determine a first current, wherein the first current is a minimum value of current required to prevent formation of hot-spots in the string of solar panels;
measure a load current, wherein the load current is the current flowing through the string of solar panels; and
determine a compensatory current, wherein the compensatory current is equal to the difference between the first current and the load current;
a first DC-to-DC converter comprising input terminals coupled to a load and output terminals coupled to each solar panel in the string of solar panels; and
a second DC-to-DC converter coupled to the first DC-to-DC converter wherein the second DC-to-DC convertor supplies a compensatory voltage for compensating a drop in the load current arising due to panel mismatch among the string of solar panels, thereby preventing hot spot formation in the string of solar panels.

16. The system as claimed in claim 15, wherein the first dc to dc convertor supplies a compensatory power for compensating a drop in the first current arising due to shading of one or more solar panels, thereby correcting hot spots in the string of solar panels.

17. The system as claimed in claim 15, wherein the microprocessor is further operable to measure voltages across solar panels in the string of solar panels, thereby detecting potential hot-spots in the string of solar panels.

18. The system as claimed in claim 15, wherein the second DC-to-DC converter adds a negative voltage in series to a voltage across the string of solar panels, if the voltage across the string of solar panels Vₛₒₗₐᵣₚₐₙₑₗ is greater than a voltage across a battery V_{load}.

19. The system as claimed in claim 15, wherein the second DC-to-DC converter adds a positive voltage in series to a voltage across the string of solar panels, if the voltage across the string of solar panels Vₛₒₗₐᵣₚₐₙₑₗ is lesser than a voltage across a battery V_{load}.

20. The system as claimed in claim 15, wherein the first DC-to-DC converter comprises a 4:1 transformer, the 4:1 transformer comprising a primary coil coupled to the load via one or more switches and a secondary coil configured as four electrically isolated outputs.

21. The system as claimed in claim 20, wherein each of the four electrically isolated outputs comprises a capacitor and a diode switch, and each of the four electrically isolated outputs being coupled to a solar panel.
